(19) United States
(12) Patent Application Publication
(10) Pub. No.: US 2021/0048833 A1
(43) Pub. Date: Feb. 18, 2021

(54) Open-land-capable robot device

(71) Applicant: Gerhard SUCKERT, Wackersdorf (DE)

(72) Inventor: Gerhard SUCKERT, Wackersdorf (DE)

(21) Appl. No.: 16/897,239

(22) Filed: Jun. 9, 2020

(30) Foreign Application Priority Data
Aug. 13, 2019 (DE) 10 2019 121 783.0

(51) Int. Cl. G05D 1/12; G05D 1/00; G05D 1/02

(52) U.S. Cl. CPC G05D 1/12; G05D 1/0094; G05D 2201/0201; G05D 1/0212; G05D 1/0022

(57) ABSTRACT

The invention relates to an open-land-capable robot device comprising at least one sensor apparatus for the detection of chip apparatuses that are arranged remotely from the robot device along open land, for example a field, comprising

a mobile frame on which at least one drive element for motor-driving the mobile frame is arranged, the sensor apparatus comprising at least one transmitting and/or receiving device for transmitting and/or receiving at least one electromagnetic signal, the drive element and/or the mobile frame being directionally controllable, such that the robot device can be controlled along a movement path, characterised in that the transmitting and/or receiving device comprises at least one sensor, the sensor being configured and intended to perform at least one chip recognition of the chip apparatus, preferably fully automatically, and unambiguously, preferably uniquely.

The present invention relates to an open-land-capable robot device comprising at least one sensor apparatus for the detection of chip apparatuses that are arranged remotely from the robot device along open land, for example a field, and to a corresponding method for operating a detection of chip apparatuses which are arranged remotely and along open land, for example a field, by means of an open-land-capable robot apparatus according to the respective preambles of claims 1 and 10.

Within the meaning of the invention, “open-land-capable robot device” means a robot device of this kind which is in particular configured and intended to be able to drive, and thus operate, preferably also freely, outside of warehouses or other enclosures, in particular in an undeveloped area. An undeveloped area within the meaning of the invention is in turn such an area, in particular such an area that is not built on, which is, for example, unpaved and/or does not have any buildings thereon.

Open-land areas formed by a field, a meadow, or another area that is not built on are therefore possible in particular.

An open-land-capable robot device in particular cannot be a robot device that can be used as part of a production and/or automation process in a factory-type environment.

The chip apparatus proposed here may be any microelectronic system which either transmits and/or receives electromagnetic radiation. For example, the chip apparatus may be an NFC chip, a Bluetooth-enabled chip or a chip based on another wireless communication standard.

Each chip apparatus can preferably be implanted in a biological body. For example, a chip apparatus can be implanted in sheep, cows, or other grazing cattle. Pets can also be considered as an implantation object. Alternatively or additionally, the chip apparatus can be inserted in clothing or a bracelet/necklace or collar. Children or adults can be unambiguously, preferably uniquely, recognised and identified solely by wearing the item of clothing.

The robot device is preferably a manageable, more preferably a portable robot device. It is conceivable that the total weight of the robot device is less than 100 kg, preferably less than 50 kg, more preferably less than 25 kg, such that the robot device can also be carried around by hand. The robot device disclosed herein also differs significantly from a robot device in a warehouse, in particular in a warehouse in which a logistics process takes place (i.e. in a factory environment) due to the weight mentioned here. Robot devices of this kind are neither intended nor configured to be carried around by hand.

According to at least one embodiment, the open-land-capable robot device comprises a mobile frame on which at least one drive element for motor-driving the mobile frame is arranged. The drive element may be an electropneumatic motor or a motor driven by fossil fuels. The drive element can preferably be remotely controlled.

According to at least one embodiment, the open-land-capable robot device and in particular the wherein the sensor apparatus comprises at least one transmitting and/or receiving device for transmitting and/or receiving at least one electromagnetic signal, the drive element and/or the mobile frame being directionally controllable, such that the robot device can be controlled along a movement path.

In other words, the transmitting and/or receiving device can control the drive element. If the transmitting and/or receiving device then receives a control signal, for example from an operator or from a base station (which can be arranged in a stationary manner relative to the open-land-capable robot device), this signal is forwarded to the drive element in a drive signal, whereupon the drive element can be controlled and/or regulated.

If, for example, the transmitting and/or receiving device receives a signal for accelerating the robot device along the movement path, this acceleration signal is forwarded to the drive element, which in turn then generates a force effect on a drive element of the mobile frame, as a result of which the mobile frame starts to move.

According to at least one embodiment, the sensor apparatus comprises at least one transmitting and/or receiving device, at least one sensor, the sensor being configured and intended to perform at least one chip recognition of the chip apparatus, preferably fully automatically, and unambiguously, preferably uniquely. The chip recognition can be based on the fact that the chip apparatus, which has been implanted in the biological body in a detachable or non-detachable manner, emits at least one signal, in particular a location signal, which contains unambiguous assignment information about itself, for a limited or unlimited time.

For example, chip apparatuses are numbered consecutively in a numerical and/or letter-based manner in the form “1, 2, 3, . . . ” and/or “a, b, c, . . . ”. The identification signal generated by the chip apparatus then comprises, at least in part, numerical coding of this kind, for example in binary form, such that the transmitting and receiving apparatus can readily unambiguously, preferably uniquely, read out the chip apparatus proposed here. Automatic, preferably fully automatic chip recognition and, in this respect, even identification of the biological body that is unambiguously, preferably uniquely, assigned to the chip is therefore possible by means of the open-land-capable robot apparatus described here. Cows, sheep or other biological bodies can therefore be unambiguously identified automatically, preferably fully automatically, in an open meadow and/or field.

According to at least one embodiment, the open-land-capable robot device comprises at least one sensor apparatus for the detection of chip apparatuses that are arranged remotely from the robot device along open land, for example a field, and at least one mobile frame on which at least one drive element for motor-driving the mobile frame is arranged.

Furthermore, the robot device comprises at least one transmitting and/or receiving apparatus for transmitting and/or receiving at least one electromagnetic signal, the drive element and/or the mobile frame being directionally controllable, such that the robot device can be controlled along a movement path. The transmitting and/or receiving apparatus is preferably completely attached to the mobile frame and/or to the drive element in a detachable or non-detachable manner.

According to at least one embodiment, the transmitting and/or receiving apparatus comprises at least one sensor, the sensor being configured and intended to perform at least one chip recognition, in particular on the basis of a signal being received or emitted, the chip apparatus and/or of itself, wherein at least one chip recognition of the chip apparatus is or can be performed, preferably fully automatically, and unambiguously, preferably uniquely.

According to at least one embodiment, the chip recognition includes a numerical and/or letter-based assignment of a particular chip apparatus. Within the meaning of the invention, numerical and/or letter-based assignment is understood to mean that each chip apparatus emits a signal and/or absorbs a signal (in the case of signal absorption, preferably a signal from the transmitting and/or receiving apparatus) and a piece of information can be contained in the signal and/or read out from the signal, which attributes a numerical and/or letter-based meaning to a chip. For example, a first chip is identified by the combination of numbers and letters “a1, b2, c3, 4, 8, 9”. For example, the respective chip apparatuses can each be named and also preferably unambiguously identified by this combination of numbers and letters. As an alternative thereto, a corresponding alias for the chip apparatus can be distributed based on the combination of numbers and letters, for example an alias can be “Chip 1”, etc.

According to at least one embodiment, the robot device comprises at least one locating apparatus which, in particular after it is put into operation, tracks the chip apparatus in time and/or in space and/or identifies the chip apparatus, preferably fully automatically, after approaching the chip apparatus within an identification radius, the locating apparatus in particular controlling the drive element.

For example, the locating apparatus can also transmit transmitted and received data from and/or to a transmitting and receiving apparatus.

The locating apparatus may therefore be an apparatus which carries out the actual chip apparatus tracking and/or chip apparatus recognition.

According to at least one embodiment, the locating apparatus is either installed on the frame at least in part or the locating apparatus forms a stationary base station completely or in part, which base station transmits control signals to the drive element for driving and/or directionally controlling the frame.

Alternatively or additionally, such a base station may also transmit corresponding drive and control signals to the transmitting and receiving apparatus.

It is conceivable for such a base station to be arranged on a boundary of corresponding open land. A user can set the boundary beforehand. It is conceivable for the base station to then be arranged in a stationary manner along a fence of such a field and/or meadow at a specific location and to control the relevant chip recognition process completely automatically or even semi-automatically.

For this purpose, it is conceivable for the open-land-capable robot device to initially be used within the area delimited by such a fence and for the stationary base station to then control the robot device.

It is conceivable for the open-land-capable robot apparatus to move off from the individual chip apparatuses along a predetermined pattern (for example, along the movement path) by means of the control signals from the relevant base station.

In this context, it is conceivable for such a movement path to be defined within a delimited area that contains certain departure points. For example, such a movement path is a zigzag-shaped, circular or otherwise shaped path, which, however, contains the corresponding departure points as dwell points that are either fixed or can be variably set.

At such departure points, the base station can be programmed such that the open-land-capable robot device stops there for a certain period of time and, starting therefrom, then starts moving again independently. During this idle time at this departure point, it may therefore be conceivable for a locating process to be carried out to determine, per se, whether the open-land-capable robot device is within an identification radius of a chip apparatus, and, if this is the case, for the open-land-capable robot device, starting from this point of departure, to point in the direction of the chip apparatus, i.e. in the direction of the biological object, and to carry out an identification there in a spherical region around the biological object (i.e. within the identification radius).

After a completed identification, the robot apparatus can therefore be controlled such that it returns to the starting departure point and continues on further along the movement path. At the end of the movement path, which is formed by at least one departure point, preferably by two or more departure points, the identification process can therefore be terminated within the delimited open land and the robot device can thus return to the base station, preferably independently, for example to be charged there.

According to at least one embodiment, the mobile frame has at least one, preferably a plurality of movement elements, in particular drive wheels, which are operated by the drive element and by means of which the robot device is moved.

According to at least one embodiment, the locating apparatus forms a control network together with the sensor, the detection, processing and/or forwarding of the sensor data from each sensor (slave) being controlled by the locating apparatus (master).

According to at least one embodiment, the control network can be subdivided into at least two network segments (VLAN), which are neurologically separated from each other, by means of at least one VLAN switch, and it being possible for each of the transmitting and/or receiving devices to be actuated on the basis of the actuation by the VLAN switch and/or the processing unit by means of each of the network segments.

According to at least one embodiment, a prioritisation of the individual network segments is carried out by means of the VLAN switch, in particular with regard to data exchange thereof.

At least one VLAN ID can be assigned to each sensor and each network segment and/or each transmitting and/or receiving apparatus, it being possible for at least one drive element to be actuated via each VLAN ID.

Furthermore, the present invention relates to a method for operating a detection of chip apparatuses arranged remotely and along open land, for example a field, by means of an open-land-capable robot apparatus, in particular one according to at least one of the above-described embodiments. This means that all features disclosed for the method described here are also disclosed for the robot device described here, and vice versa.

In a first step, a robot device according to at least one of the above-described embodiments is initially provided.

In a second step, the robot device is put into operation, wherein the robot device then, preferably fully automatically, detects at least one chip apparatus and locates it down to the accuracy of an identification radius, and then the robot device proceeds into the identification radius of the chip apparatus and, within said radius, performs the chip recognition of the chip apparatus.

All the advantages and advantageous embodiments of the robot device described above are also disclosed for the method described here, and vice versa.

The invention is described in greater detail in the following with reference to a FIGURE and the corresponding reference signs.

FIG. 1 is a schematic plan view of an open-land-capable robot device, and in particular also shows a method described here for detecting the individual chip apparatuses along an open field.

In the drawings, identical or equivalent components are provided with the same reference signs, even if individual components may be exaggerated in size.

FIG. 1 shows an open-land-capable robot apparatus 100, which comprises a sensor apparatus 1.

The open-land-capable robot apparatus comprises a mobile frame 2 and a drive element 3, the drive element 3 being detachably mounted on the frame 2. The drive element 3 and the frame 2 are therefore interconnected, for example screwed, soldered or riveted to one another.

Furthermore, a transmitting and receiving apparatus 4 for transmitting and/or receiving at least one electromagnetic signal is arranged on the frame 2, the drive element 3 and the frame 2 being controllable in terms of direction and propulsion, such that the robot device 100 can be controlled along a movement path P1. The transmitting and receiving apparatus 4 comprises at least one sensor 51, the sensor 51 being configured and intended to perform at least one chip recognition of the chip apparatus 1A.

Furthermore, the robot device 100 comprises a locating apparatus 6, which is in the form of a base station and is arranged on the boundary of the open land AI that is and/or can be delimited. The locating apparatus 6 can control the open-land-capable robot apparatus along a movement path P1. Also shown is an identification radius R1 in a radial representation around the relevant chip apparatus 1A. The chip apparatus 1A is preferably arranged in a biological body and moves therewith.

The frame 2 also comprises a plurality of movement elements 21.

It can also be seen that the locating apparatus 6 forms a control network 41 together with the sensor 51, the control network 41 in turn comprising a VLAN switch 52, on the basis of which two neurologically separate network segments 60, 61 (VLAN) are produced and can be actuated between the individual network segments by means of a VLAN switch 52. A separate VLAN ID can be assigned to each sensor 51 and/or each network segment 60, 61 and/or the receiving apparatus 4, such that it is not only possible to depart along the movement path, but also to divide the movement path into individual network segments as part of the control along the movement path.

### LIST OF REFERENCE SIGNS

1 Sensor apparatus
2 Mobile frame
3 Drive element
4 Transmitting and receiving apparatus
6 Locating apparatus
21 Movement elements
41 Control network

### 51 Sensor

52 VLAN switch
60 Network segment
61 Network segment
100 Open-land-capable robot apparatus
1A Chip apparatus
P1 Movement path
R1 Identification radius
AI Open land, field

1. Open-land-capable robot device (100) comprising at least one sensor apparatus (1) for the detection of chip apparatuses (1A) that are arranged remotely from the robot device (100) along open land, for example a field (AI), comprising
a mobile frame (2) on which at least one drive element (3) for motor-driving the mobile frame (2) is arranged,
the sensor apparatus (1) comprising at least one transmitting and/or receiving device (4) for transmitting and/or receiving at least one electromagnetic signal, the drive element (3) and/or the mobile frame (2) being directionally controllable, such that the robot device (100) can be controlled along a movement path (P1),
characterised in that
the transmitting and/or receiving device (4) comprises at least one sensor (51), the sensor (51) being configured and intended to perform at least one chip recognition of the chip apparatus (1A), preferably fully automatically, and unambiguously, preferably uniquely.

2. Robot device (100) according to claim 1,
characterised in that
chip recognition includes a numerical and/or letter-based assignment of a particular chip apparatus (1A).

3. Robot device (100) according to either claim 1,
characterised by
at least one locating apparatus (6) which, in particular after it is put into operation, tracks the chip apparatus (1A) in time and/or in space, and/or identifies the chip apparatus (1A), preferably fully automatically, after approaching the chip apparatus (1A) within an identification radius (R1), the locating apparatus (6) in particular controlling the drive element.

4. Robot device (100) according to claim 3,
characterised in that the locating apparatus (6) is either installed on the frame (2) at least in part or the locating apparatus (6) completely forms a stationary base station, which transmits control signals to the drive element (3) for driving and/or directionally controlling the frame (2).

5. Robot device (100) according to claim 1,
characterised in that
the mobile frame (2) has at least one, preferably a plurality of movement elements (21), in particular drive wheels (21), which are operated by the drive element (3) and by means of which the robot device (100) is moved.

6. Robot device (100) according to claim 1,
characterised in that
the locating apparatus (6) forms a control network (41) together with the sensor (51), the detection, processing and/or forwarding of the sensor data from each sensor (slave) being controlled by the locating apparatus (6) (master).

7. Robot device (100) according to claim 1,
characterised in that
the control network (41) can be subdivided into at least two network segments (60, 61) (VLAN), which are only logically separated from each other, by means of at least one VLAN switch (52), and it being possible for each of the transmitting and/or receiving devices (4) to be actuated on the basis of the actuation by the VLAN switch (52) and/or the processing unit by means of each of the network segments (60, 61).

8. Robot device (100) according to claim 4,
characterised in that
a prioritisation of the individual network segments (60, 61) is carried out by means of the VLAN switch (52), in particular with regard to the data exchange thereof.

9. Robot device (100) according to claim 8,
characterised in that
at least one VLAN ID is assigned to each sensor (51) and/or each network segment (60, 61) and/or each transmitting and/or receiving device (4), it being possible to actuate at least one drive element (3) via each of the VLAN IDs.

10. Method (1000) for operating a detection of chip apparatuses which are arranged remotely and along open land, for example a field, by means of an open-land-capable robot apparatus (100), comprising the following steps:
providing at least one robot device (100) according to claim 1,
putting the robot device (100) into operation, wherein the robot device (100) then, preferably fully automatically, detects at least one chip apparatus (1A) and locates it down to the accuracy of an identification radius (R1), and then the robot device (100) proceeds into the identification radius (R1) of the chip apparatus (1A) and, within said radius,
performs the chip recognition of the chip apparatus (1A).
